(19) United States
(12) Patent Application Publication
(10) Pub. No.: US 2015/0005935 A1
(43) Pub. Date: Jan. 1, 2015

(54) CENTRAL DISPENSING MANAGEMENT SYSTEM

(71) Applicant: INFOPIA CO., LTD., Anyang-si (KR)

(72) Inventors: Byeong-Woo Bae, Anyang-si (KR); Keun-Young Kim, Seoul (KR)

(73) Assignee: INFOPIA CO., LTD., Anyang-si (KR)

(21) Appl. No.: 14/317,635

(22) Filed: Jun. 27, 2014

(30) Foreign Application Priority Data
Jun. 28, 2013 (KR) 10-2013-0075895

(51) Int. Cl. G06F 19/00; G07F 11/00; G07F 17/00

(52) U.S. Cl. CPC G06F 19/3462; G07F 17/0092; G07F 11/002
USPC 700/241

(57) ABSTRACT

A central dispensing management system, which includes an integrated management server and a plurality of dispensing management clients. The integrated management server transmits dispensing data of prescription drugs to the plurality of dispensing management clients in conjunction with a prescription server. The plurality of dispensing management clients control dispensers to automatically dispense medicines.

### CROSS-REFERENCE TO RELATED APPLICATION(S)

This application claims priority from Korean Patent Application No. 10-2013-0075895, filed on Jun. 28, 2013, in the Korean Intellectual Property Office, the entire disclosure of which is incorporated herein by reference for all purposes.

### BACKGROUND

1. Field

The following description relates generally to a technology for automated dispensing of prescription medicines, and more particularly to a technology for central management of a plurality of dispensers.

2. Description of the Related Art

A management system for medical consultation and dispensing of prescription medicines using a network is widely known, as disclosed in Korean Patent No. 10-1183984. The system connects consultation offices, drug dispensing establishments, and health insurance companies through a network, and has a main server that includes a healthcare establishment server, a dispensing establishment server, and a health insurance company server. In the healthcare establishment server, patient consultation information is registered from consultation offices, to check and manage duplicate consultations. In the dispensing establishment server, information on dispensing of prescription medications is registered from dispensing establishments, to check and manage overuse and duplicate prescription of medicines. In the health insurance company server, consultation and dispensing fees, as well as prescription medication costs requested by consultation offices and dispensing establishments, are examined, and information thereon is registered and managed. In such a conventional system, dispensing establishments, such as pharmacies and the like, have been managed: to prevent duplicate prescriptions; to control the medical benefit period of 365 days and medical costs of people eligible for the benefits; to manage medication usage history of each patient; and to control medication dose limits for patients who have been treated with the medication more than twice, and consultation offices have been managed to check in advance duplicate consultations and eligibility of people for medical benefits, as well as excessive consultations.

### RELATED ART DOCUMENT

Korean Patent No. 10-1183984 (published on Sep. 12, 2012)

### SUMMARY

The present disclosure provides a central dispensing management system, which allows remote controlling and managing of dispensers that are apart from each other in different locations, as well as remote diagnoses and management of patients' conditions.

Further, the present disclosure also provides a central dispensing system, which allows automatic management of cartridges of dispensing apparatuses.

In one general aspect, there is provided a central dispensing management system, which includes: a prescription server configured to manage prescription data; an integrated management server configured to receive the prescription data to generate dispensing data that includes information on drug administration; and a plurality of dispensing management clients configured to control dispensers according to the dispensing data, and to receive image data associated with dispensing according to the controlling, wherein the plurality of dispensing management clients provide information to a user terminal or to the integrated management server based on the image data associated with the dispensing.

The integrated management server may include: a communication interface configured to be used for communication between the prescription server and consultation offices; a data processor configured to parse data received from the prescription server through the communication interface, and to transmit diagnosis data of patients to the prescription server through the communication interface; and a prescription data processor configured to generate dispensing data that includes information on drug administration based on the prescription data obtained by the parsing by the data processor, and to transmit the generated dispensing data to the plurality of dispensing management clients.

The integrated management server may further include a diagnosis data processor configured to receive measuring data of patients' conditions from a diagnostor connected to a serial interface, and to receive information on patients from a reader connected to the serial interface, so as to generate diagnosis data that includes the received measuring data of patients' conditions and the information on patients, or to process diagnosis data received from the plurality of dispensing management clients.

The integrated management server may further include a database server configured to manage the prescription data obtained by the parsing by the data processor in a database, to manage the diagnosis data processed by the diagnosis data processor in the database, and to receive data of camera-captured dispensing images associated with the dispensing by the dispensers from the plurality of dispensing management clients to manage the data of camera-captured dispensing images in the database.

The plurality of dispensing management clients may include: a controller configured to control the dispensers to perform dispensing according to the dispensing data received from the integrated management server; and a dispensing image processor configured to receive, from the dispensers, data of camera-captured dispensing images associated with dispensing results to output the data to a screen of the user terminal through a user interface, and to transmit the received data of camera-captured dispensing images to the integrated management server.

The dispensing image processor may be configured to receive, from the dispensers, the camera-captured dispensing images and result data on a determination of whether there is a dispensing error based on the camera-captured dispensing images, to output the received data to a screen of the user terminal through the user interface; and the controller may be configured to control the dispensers to progress dispensing or to perform redispensing according to a user's instruction input through the user interface.

The plurality of dispensing management clients may further include a diagnosis data receiver configured to receive measuring data of patients' conditions from a diagnostor connected to a serial interface, and to receive information on patients from a reader connected to the serial interface, so as to generate diagnosis data that includes the received measuring data of patients' conditions and the information on patients, and to transmit the generated diagnosis data to the integrated management server.

The integrated management server may further include a cartridge manager configured to manage inventory of medicines stored in each cartridge used by the dispensers in the database, and to manage a cartridge to be replaced with a new cartridge in response to a stock of medicines in the cartridge being below a predetermined optimal number of stocks.

The integrated management server may further include a cartridge manager configured to manage inventory of medicines stored in each cartridge used by the dispensers by using the database, and to determine, based on a usage history of each cartridge, whether inventory of medicines is below an optimal number of stocks that is changeable, so as to manage a cartridge to be replaced with a new cartridge in response to a determination that a stock of medicines in the cartridge is below the optimal number of stocks.

The usage history may be usage patterns on a monthly, weekly, daily, and hourly basis.

In another general aspect, there is provided a central dispensing management method of an integrated management server, the method, which is performed in a central dispensing management system including a prescription server, the integrated management server, and a plurality of dispensing management clients, including: parsing data received from the prescription server; separating prescription data from the parsed data; generating dispensing data that includes information on drug administration based on the prescription data; and transmitting the generated dispensing data to the plurality of dispensing management clients.

The central dispensing management method of the integrated management server may further include storing information on dispensing results and information on dispensing images received from the plurality of dispensing management clients.

The central dispensing management method of the plurality of dispensing management clients may further include: controlling dispensers to perform dispensing according to dispensing data received from the integrated management server; receiving data of camera-captured dispensing images associated with dispensing results from the dispensers; and outputting the received data of camera-captured dispensing images to a screen of a user terminal, or transmitting the received data of camera-captured dispensing images to the integrated management server.

The central dispensing management method of the plurality of dispensing management clients may further include: controlling dispensers to perform dispensing according to dispensing data received from the integrated management server; receiving, from the dispensers, data of camera-captured dispensing images associated with dispensing results and result data on a determination of whether there is a dispensing error; outputting the received data of camera-captured dispensing images and the received result data on a determination of whether there is a dispensing error; and controlling the dispensers to progress dispensing or to perform redispensing according to a user's instruction input through a user interface.

The central dispensing management method of the plurality of dispensing management clients may further include: receiving information on patients from a reader; receiving measuring data of patients' conditions from a diagnostor; generating diagnosis data that includes the received information on patients and the received measuring data of patients' conditions; and transmitting the generated diagnosis data to the integrated management server.

The central dispensing management method of the integrated management server may further include: receiving diagnosis data from the plurality of management clients; converting a format of the received diagnosis data; and transmitting the format-converted diagnosis data to the prescription server.

The central dispensing management method of the integrated management server may further include: managing inventory of medicines stored in each cartridge used by the dispensers in a database; and managing a cartridge to be replaced with a new cartridge in response to a stock of medicines in the cartridge being below a predetermined optimal number of stocks.

### BRIEF DESCRIPTION OF THE DRAWINGS

FIG. 1 is a diagram illustrating an example of a central dispensing system according to an exemplary embodiment.

FIG. 2 is a block diagram illustrating an example of an integrated management server and a dispensing management client according to an exemplary embodiment.

FIG. 3 is a block diagram illustrating an example of database information of an integrated management server and its process according to an exemplary embodiment.

FIG. 4 is a block diagram illustrating an example of a prescribing/dispensing process of a central dispensing system according to an exemplary embodiment.

FIG. 5 is a block diagram illustrating an example of a measuring process performed by a diagnostor of a central dispensing system according to an exemplary embodiment.

FIG. 6 is a block diagram illustrating an example of a cartridge management process performed by a central dispensing system according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

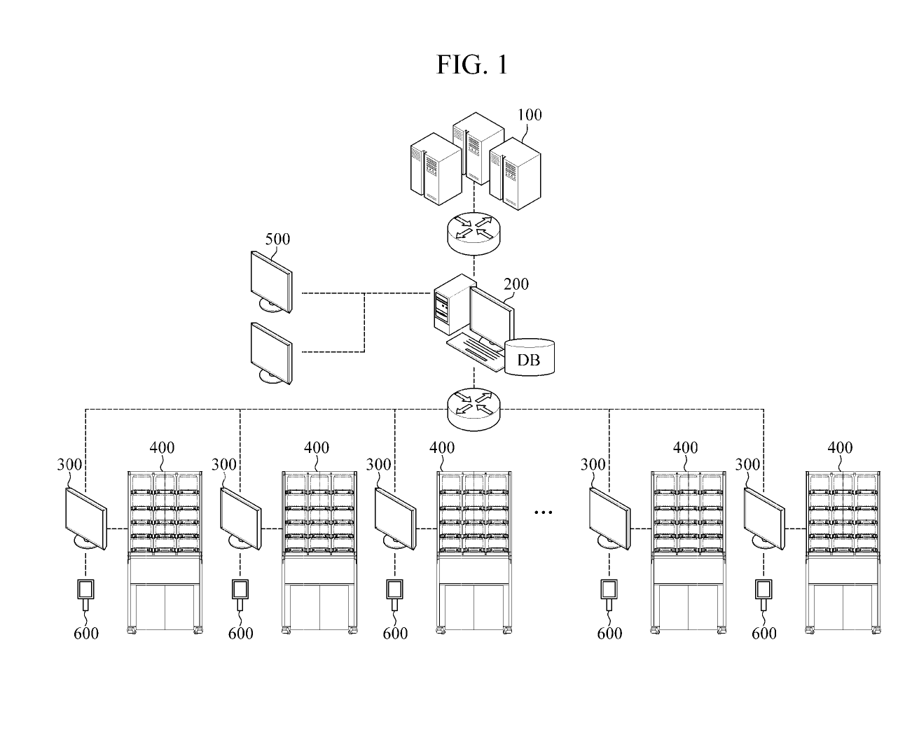

FIG. 1 is a diagram illustrating an example of a central dispensing system according to an exemplary embodiment.

The central dispensing system includes a prescription server 100, an integrated management server 200, a plurality of dispensing management clients 300 and dispensers 400. The prescription server 100 basically manages doctors' prescriptions as prescription data. In an exemplary embodiment, the prescription server 100 may be a Health Level 7 (HL7) server. It is well known that the HL7 refers to a non-profit organization that produces a set of international standards in healthcare informatics. Here, the prescription server 100 may be an HL7 server, but is not limited thereto.

The integrated management server 200 is connected through a network to the prescription server 100 and to a plurality of dispensing management clients 300. Further, the integrated management server 200 may be connected with a user (manager) terminal. The integrated management server 200 receives prescription data from the prescription server 100 to generate dispensing data based on the received prescription data, and transmits the generated dispensing data to the dispensing management client 300. Further, the integrated management server 200 receives patient diagnosis data from the dispensing management client 300 to manage the received data in a database, and to transmit the received data to the prescription server 100. The integrated management server 200 receives, from the dispensing management client 300, data of dispensing images captured by cameras that are related to dispensation results, to manage the received data in a database and to transmit the data to the prescription server 100. The integrated management server 200 manages states of prescription and dispensing of each medicine to check inventory of medicines and to determine whether to collect/deliver cartridges. Further, the integrated management server 200 provides a communication interface with a user terminal 500. Accordingly, the user (manager) may refer to information managed in the integrated management server 200, and may transmit instructions to the integrated management server 200.

The dispensing management client 300 receives dispensing data from the integrated management server 200, and controls the dispenser 400 based on the received dispensing data to dispense prescribed medicines. Further, the dispensing management client 300 receives, from the dispenser 400, data of dispensing images captured by a camera that are related to dispensing results, and transmits the received data to the user terminal 510 or to the integrated management server 200. The dispensing management client 300 receives measuring data of patients' conditions from a diagnostor 600, which may communicate with the dispensing management client 300, and transmits the received data to the integrated management server 200. The dispenser 400 may be an automatic dispenser used in hospitals or pharmacies, or may be a dispenser for home use. The dispenser 400 discharges medicines from cartridges where medicines are stored to be dispensed according to dispensing data of the dispensing management client 300, in which medicines may be dispensed in a unit dose package. Once medicines dispensed in a unit does are collected in a hopper, the dispenser 400 may acquire dispensing images by capturing them with a camera provided at the top of the hopper, and may transmit the acquired dispensing images to the dispensing management client 300.

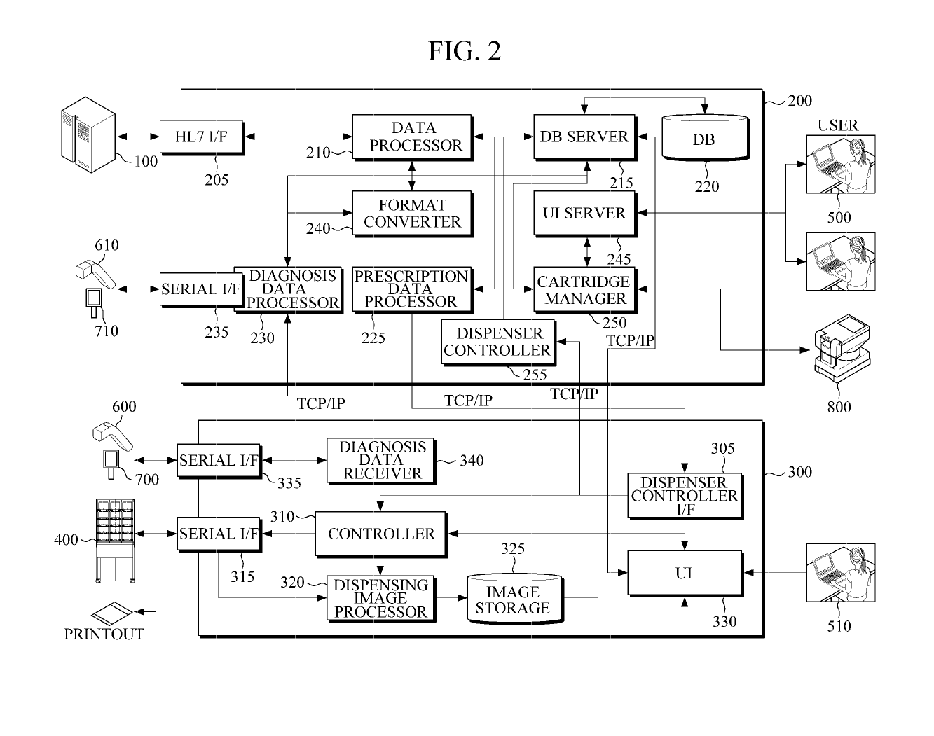

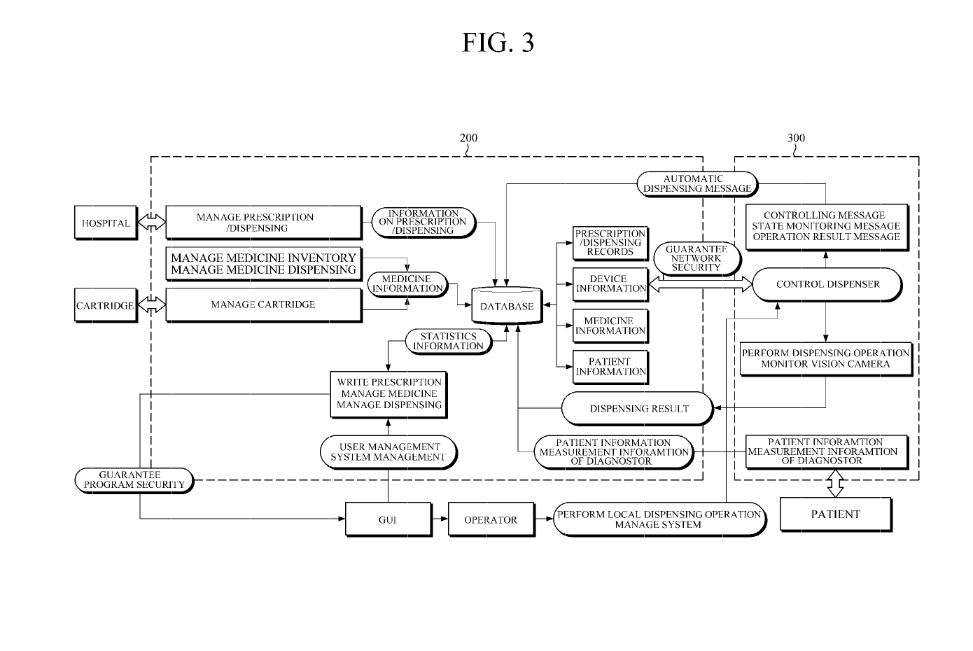

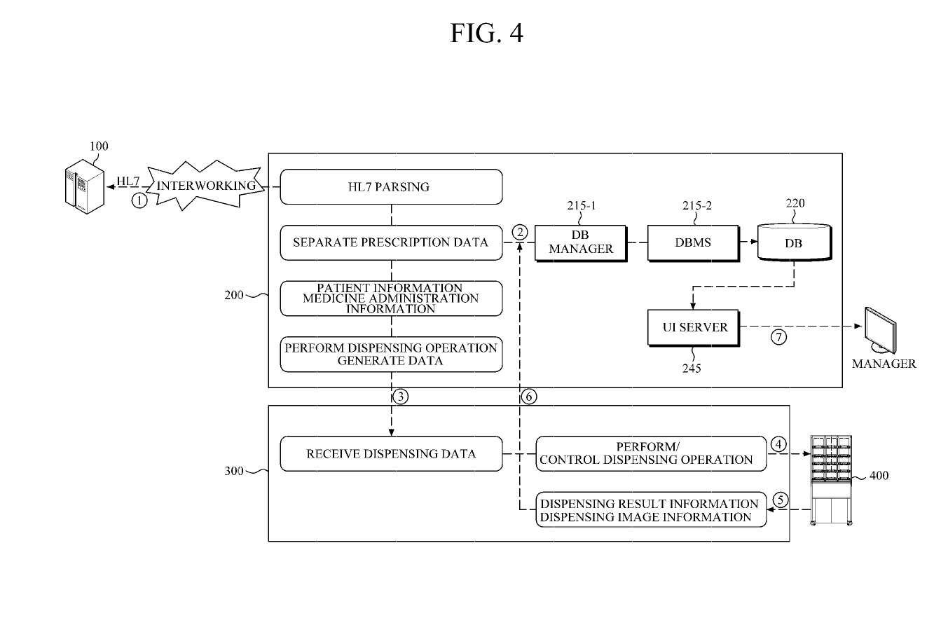

FIG. 2 is a block diagram illustrating an example of an integrated management server and a dispensing management client according to an exemplary embodiment. FIG. 3 is a block diagram illustrating an example of database information of an integrated management server and its process according to an exemplary embodiment. FIG. 4 is a block diagram illustrating an example of a prescribing/dispensing process of a central dispensing system according to an exemplary embodiment.

First, the integrated management server 200 will be described with reference to FIG. 2. A communication interface 205 is an interface for communication with the prescription server 100. In the exemplary embodiment, the communication interface 205 is configured as an interface according to the HL7 standard for communication with the prescription server 100 for consultation offices. Alternatively, the communication interface 100 may be configured as an interface for communication according to XML, HTTP, Socket, SOAP, or the like, rather than the HL7 . Hereinafter, it is assumed that the communication interface 205 is the HL7 interface. A data processor 210 parses HL7 data received through the communication interface 205. Prescription data is obtained by the parsing of HL7 data, and a database server 215 inputs this prescription data into a database 220 to manage the data. Here, the database server 215 may include a database (DB) manager and a database management system (DBMS). Further, a prescription data processor 225 generates dispensing data using the prescription data obtained from the data processor 210, and transmits the generated dispensing data to the dispensing management client 300 using a transmission control protocol (TCP) or Internet protocol (IP).

A diagnosis data processor 230 may receive data on patients' conditions from the diagnostor 610 connected to a serial interface (Serial I/F) 235, or may receive information on patients from a reader 710 connected to the serial interface 235. The diagnostor 610 is a device used to measure and diagnose patients' medical conditions, and examples thereof include a blood glucose monitoring device, an HbAlc measuring device, a cholesterol measuring device, a liver function tester, a cardiovascular disease diagnostic device, a cancer diagnostic device, a real-time PCR, a molecular diagnostic device, an oxygen saturation measuring device, an electrocardiogram measuring device, an endoscope for home use, and the like. The reader 710 reads patient information, and codes assigned to each patient, and examples thereof include a barcode scanner, an RFID reader, an NFC reader, and the like. The diagnosis data processor 230 combines patient information and measuring data of patients' conditions to generate diagnosis data. Further, the diagnosis data processor 230 may receive measuring data of patients' conditions and diagnosis data including patient information from the dispensing management client 300 through a TCP/IP.

The diagnosis data processor 230 may transmit the diagnosis data to the database server 215, and the database server 215 may input the diagnosis data into the database 220 to manage the data. Further, the diagnosis data processor 230 may transmit the diagnosis data to a format converter 240. The format converter 230 converts the diagnosis data and patient information in an XML format into an HL7 format. For reference, if the communication interface 205 conforms to an XML standard, the format converter 240 may be omitted. The converted HL7 data is output to the output processor 210, and the output processor 210 transmits the input HL7 data to the prescription server 100 through the communication interface 205. Accordingly, doctors may check diagnosis data through the prescription server 100, and may determine response to medications in patients, or side effects or effects of medications, to take actions such as changing or stopping prescriptions, or the like.

The user interface (UI) server 245 may manage client connection/disconnection, I/O data processing, UI manager API, user verification API, database manager I/F, client setting, or the like. A cartridge manager 250 may process a management UI of a cartridge 800, collecting/delivering cartridges, controlling cartridge security, cartridge reports, and the like. Further, a dispenser controller 255 may remotely control the dispenser 400 through the dispensing management client 300, and may monitor operations of the dispenser 400.

The cartridge manager 250 will be described in further detail hereinafter. The cartridge manager 250 is required to constantly update and manage a current number of stocks of each cartridge. For example, every time prescription data is generated, or the dispenser 400 actually performs dispensing operations, a number representing stocks of each cartridge for prescription/dispensing of medicines may be updated and managed. The cartridge manager 250 may update and manage a number of cartridge stocks every time prescription data is received through the communication interface 205, or by receiving, from the dispensing management client 300, information on the number of cartridge stocks, which is updated according to dispensing operations performed by the dispenser 400.

Further, based on a predetermined minimum level of stocks considered to be optimal, and on a current number of stocks of each cartridge, the cartridge manager 250 may instruct refilling of a cartridge if its stock is below the predetermined optimal minimum level of stocks. As patterns of medicine consumption and a number of managed stocks may differ depending on positions and features of hospitals and pharmacies, automatic options may be set so that cartridges may be instructed to be refilled adaptively according to various environments based on cartridge usage history on a monthly, weekly, daily, or hourly basis. For example, in a case where 99 pills remain in each of two types of cartridges, and an optimal minimum level of stocks is 100, if 50 pills are usually dispensed per day, the cartridges definitely need to be refilled, but if about one pill is usually dispensed per day, the cartridges are not necessarily refilled immediately, and thus, automatic option may be set to delay refilling of the cartridges. If an automatic option is set, the cartridge manager 250 may instruct cartridges to be refilled based on cartridge usage history on a monthly, weekly, daily, or hourly basis. For example, based on usage history, refilling may be instructed predetermined days (e.g., three days) before cartridge inventory is expected to be out of stock. That is, the cartridge manager 250 determines whether medicine inventory is below an optimal number of stocks based on dispensing history of each cartridge, and if medicine inventory is determined to be below an optimal number of stocks, which may be changeable, the cartridge may be controlled to be replaced with a new one.

The refilling instruction of the cartridge manager 250 will be described hereinafter. The cartridge manager 250 may instruct a user to refill unit quantity of medicines in an empty cartridge 800 where medicines have not yet been filled, and the user replenishes as many medicines as the unit quantity thereof in the empty cartridge 800 to which the medicine is designated to be refilled.

Once refilling is complete, the cartridge manager 250 updates tag information of the cartridge 800. The tag information includes information on medicines, such as names and codes of medicines, and the like. Upon updating the tag information, a user attaches a printed barcode to the cartridge 800 to verify the cartridge 800, which is sealed with the barcode. Then, the cartridge 800 is delivered with its position monitored through transit distribution systems to check whether delivery is done properly. After being delivered, the cartridge 800 is verified with its barcode and/or its tag, and is mounted on a position identified on the dispenser 400. The dispenser 400 checks whether the cartridge 800 is mounted properly thereon, and transmits information, which indicates the mounting of the cartridge 800 is complete, to the integrated management server 200 through the dispensing management client 300. The mounting is immediately monitored to determine whether mounting was done properly or if there is an error.

There may be exceptional cases in cartridge refill instructions. For example, in a case where medicines may not be delivered by being refilled in cartridges due to a constraint on the types and sizes of medicines, such as innovation medicines, blister-packed medicines, bottled medicines, or packed powder medicines, medicines may be delivered in an MDC tray with its information written on a tag or input into a barcode, or may be delivered separately, and if necessary, several auxiliary trays may be delivered, in which case, the dispensers 400 may perform its operations in the same manner as a cartridge.

Subsequently, the dispensing management client 300 illustrated in FIG. 2 will be described hereinafter. A dispenser controller interface 305 receives dispensing data from the integrated management server 200 through the TCP/IP, and transmits the received dispensing data to the controller 310. Upon receiving the dispensing data, the controller 310 transmits the received data to the dispenser 400 through the serial interface 315, so that medicines may be dispensed based on the dispensing data. The dispenser 400 dispenses medicines according to the dispensing data, and captures images of medicines dispensed in a unit dose that have been collected in a hopper in the dispensing process. The dispenser 400 transmits data of dispensing images captured by a camera to the dispensing management client 300. Then, the dispenser 400 analyzes the data of dispensing images to determine whether medicines are dispensed properly according to the dispensing data, and transmits the determination result data to the dispensing management client 300 along with the data of camera-captured dispensing images. That is, result data on determination of whether there is an error in dispensing medicines may be transmitted to the dispensing management client 300 along with data of dispensing images captured by a camera.

The serial interface 315 of the dispensing management client 300 receives data of the camera-captured dispensing images, and outputs the data to a dispensing image processor 320. The dispensing image processor 320 stores the input data of dispensing images in an image storage 325, and the data of dispensing images stored in the image storage 325 is provided to the user terminal 510 through the UI 330. If result data on the determination of whether there is a dispensing error is received along with the data of dispensing images, the determination result data may also be provided to the user terminal 510 through the UI 330. The user terminal 510 outputs the data of camera-captured dispensing images to a screen along with the result data on the determination of whether there is a dispensing error. Accordingly, a user may personally check the camera-captured dispensing images displayed on a screen, or along with the determination result on whether there is a dispensing error.

Further, based on the check, a user may instruct dispensing to progress, or instruct redispensing. The user terminal 510 transmits a user's instruction data to the dispensing management client 300, and the UI 330 of the dispensing management client 300 transmits the user's instruction data to the controller 310. The controller 310 transmits a dispensing control signal for progressing dispensing or redispensing according to the user's instruction data. In response to the dispensing control signal, the dispenser 400 progresses a dispensing process or performs a redispensing process. In a case where a dispensing process progresses, medicines dispensed in a unit dose that have been collected in a hopper are discharged into a packaging area to complete dispensing. In a case where a redispensing process is performed, medicines dispensed in a unit dose that have been collected in a hopper are discharged not into a packaging area but into a recovery area to be recovered, and then, medicines are dispensed again in a unit dose. If there is no such process of dispensing or of redispensing according to a user's instruction as described above, medicines dispensed in a unit dose that have been collected in a hopper are automatically discharged into a packaging unit after a specific lapse of time, so that dispensing may normally progress.

The data of camera-captured dispensing images may be transmitted to the integrated management server 200. A database server 215 of the integrated management server 200 may manage the transmitted data of dispensing images by inputting the data in a database 220. In this case, result data of determination on whether there is a dispensing error may also be transmitted to the integrated management server 200 to be managed. The diagnosis data receiver 340 may receive measuring data of patients' conditions from the diagnostor 600 connected to the serial interface 335. Further, the diagnosis data receiver 340 may receive patient information from a reader 700 connected to the serial interface 335. The diagnostor 600 is a device to measure and diagnose patients' medical conditions, and examples thereof include a blood glucose monitoring device, an HbAlc measuring device, a cholesterol measuring device, a liver function tester, a cardiovascular disease diagnostic device, a cancer diagnostic device, a real-time PCR, a molecular diagnostic device, an oxygen saturation measuring device, an electrocardiogram measuring device, an endoscope for home use, and the like. The reader 710 reads patient information and codes assigned to each patient, and examples thereof include a barcode scanner, an RFID reader, an NFC reader, and the like. The diagnosis data receiver 340 combines patient information and measuring data of patients' conditions received from the diagnostor 600 and the reader 700 to generate diagnosis data, and transmits the generated diagnosis data to the integrated management server 200 using the TCP/IP. The diagnosis data transmitted to the integrated management server 200 is input into the diagnosis data processor 230 to be processed.

The controller 310 may control or monitor overall operations of the dispenser 400, and according to remote control instructions of the integrated management server 200, the controller 310 may control or monitor overall operations of the dispenser 400. The controller 310 receives, from the dispenser 400, information on the number of stocks of cartridges, on which information has been updated, and transmits the received information to the integrated management server 200. Accordingly, the number of stocks of all cartridges may be managed comprehensively in the integrated management server 200. The controller 310 may also control printing of details associated with dispensing of medicines.

FIG. 3 is a block diagram illustrating an example of database information of an integrated management server and it process according to an exemplary embodiment.

The integrated management server 200 manages information on a prescribing/dispensing of medicines, information on medicines, and the like using the database 220, and receives dispensing results from the dispensing management client 300 to manage the received dispensing results using the database 220. Further, the integrated management server 200 receives information on patient diagnoses from the dispensing management client 300 to manage the information using the database 220. In addition, the integrated management server 200 may manage information on medicines, information on patients, and the like using the database 220, and other various information may also be managed using the database 220.

FIG. 4 is a block diagram illustrating an example of a prescribing/dispensing process of a central dispensing system according to an exemplary embodiment.

The integrated management server 200 receives HL7 data in (1). The integrated management server 200 parses the received data, separates prescription data from the parsed data, and stores the separated data in the database 220 through the database server 215 in (2). Further, the integrated management server 200 generates dispensing data with information on patients and on drug administration included in the prescription data, and transmits the generated dispensing data to the dispensing management client 300 in (3). The dispensing data may include only the information on drug administration, i.e., information on medicines, and information on patients may or may not be included in the dispensing data. That is, there may a case where medicines may be dispensed in a unit dose using only the information on medicines, such that the prescription data may not include information on patients. In this case, as medicines are packaged first, and prescriptions are issued thereafter, information on whether medicines are administered to patients should be input through a barcode, and the like, when treating patients.

The dispensing management client 300 receives the dispensing data through the integrated management server 200, and controls a process of dispensing with the dispenser 400 according to the received dispensing data in (4). In response to the control, the dispenser 400 performs a dispensing process, and transmits information on dispensing results and information on dispensing images to the dispensing management client 300 in (5). Here, the information on dispensing results may be the result data on determination of whether there is a dispensing error described above, and the information on dispensing images may be the data of dispensing images described above. The dispensing management client 300 transmits the information on dispensing results and the information on dispensing images to the integrated management client 200, and the integrated management server 200 stores the information on dispensing results and the information on dispensing images in the database 220 through the database manager 215-1 and the DBMS 215-2 in (6). Information managed in the database 220 may be provided to a manager through the UI server 245 in (7).

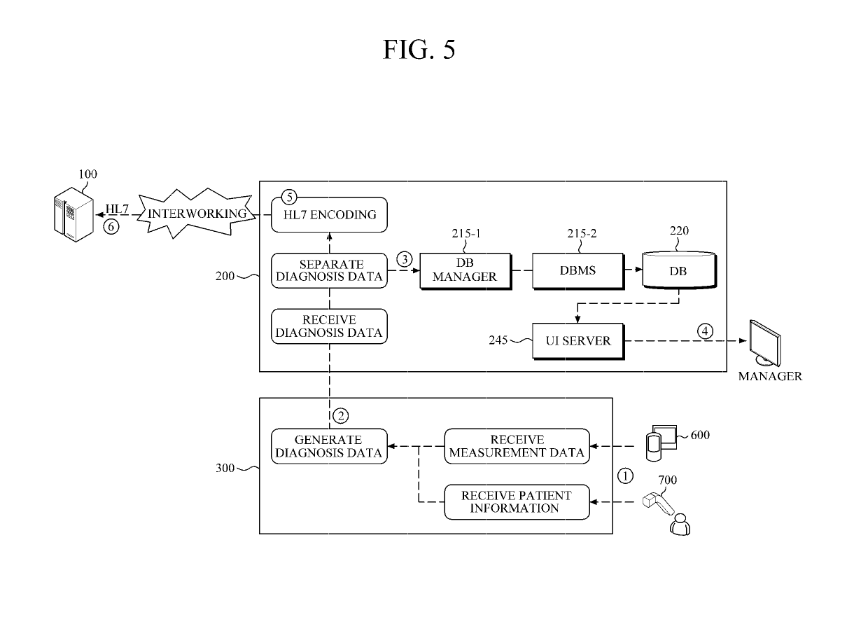

FIG. 5 is a block diagram illustrating an example of a measuring process performed by a diagnostor of a central dispensing system according to an exemplary embodiment.

The dispensing management client 300 receives information on patients from the reader 700, and receives measuring data of patients' medical conditions from one or more of diagnostors 600 in (1). The dispensing management client 300 generates diagnosis data that includes the received information on patients and measuring data of patients' medical conditions, and transmits the generated diagnosis data to the integrated management server 200 in (2). Upon receiving the diagnosis data from the dispensing management client 300, the integrated management server 200 stores the received diagnosis data in the database 220 through the database manager 215-1 and the DBMS 215-2 in (3). The stored diagnosis data may be provided to a manager through the UI server 245 and the UI manager 24501 in (4). Further, the integrated management server 200 encodes the received diagnosis data into an HLT data in (5), and transmits the encoded HLT data to the prescription server 100 for consultation offices in (6).

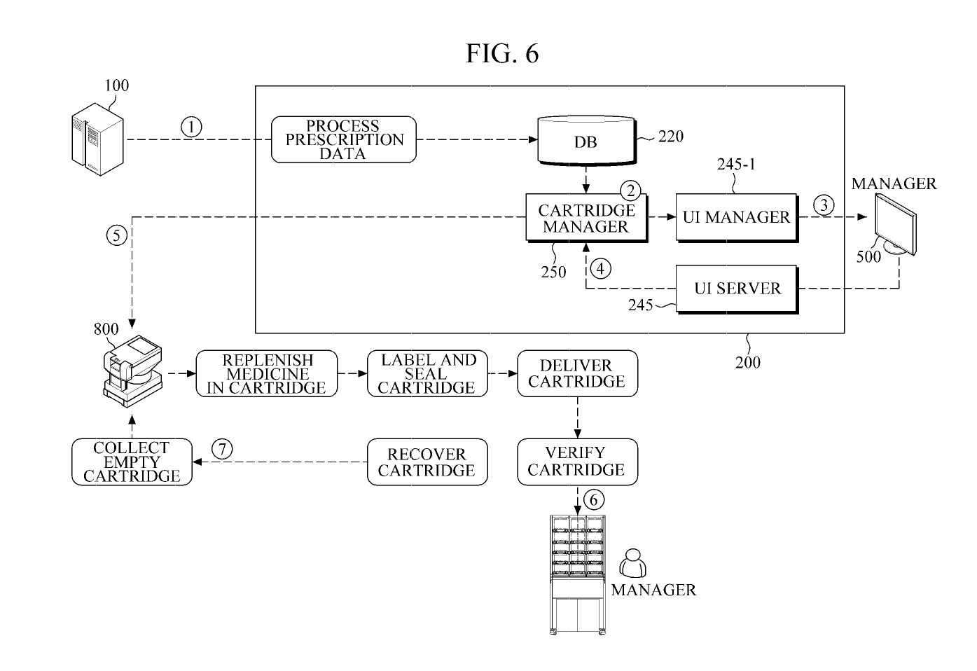

FIG. 6 is a block diagram illustrating an example of a cartridge management process performed by a central dispensing system according to an exemplary embodiment.

The prescription server 100 transmits prescription data to the integrated management server 200. Upon receiving the prescription data from the prescription server 100, the integrated management server 200 processes the received prescription data to store the data in the database 220 in (1). By referring to the database 220, the cartridge manager 250 of the integrated management server 200 monitors states of medicine stocks in each cartridge 800 of the dispensing management client 300 at all times. Further, the cartridge manager 250 monitors inventory of prescribed medicines according to the prescription data newly stored in the database 220 in (2). The cartridge manager 250 provides information on the monitored inventory of medicines to the UI manager 245-1 of the UI server 245, and the UI manager 245-1 transmits the provided information on inventory of medicines to the user terminal 500 in (3). The user terminal 500 displays the information on inventory of medicines. If medicines are out of stock, a manager inputs an instruction to deliver cartridges through a GUI of the user terminal 500. The user terminal 500 transmits the manager's instruction to deliver cartridges to the UI server 245 of the integrated management server 200, and the UI server 245 transmits the instruction to deliver cartridges to the cartridge manager 250 in (4). Upon receiving the instruction, the cartridge manager 250 records medicine information on cartridges to be delivered in (5). In the exemplary embodiment, the cartridge manager 250 may record medicine information on an NFC tag provided for the cartridge 800 by using an NFC reader. Further, the cartridge manager 250 may additionally record codes for cartridge verification on the NFC tag. The cartridge 800, which has been instructed to be delivered, is filled with medicines, to be labeled and sealed for delivery. The delivered cartridge 800 is verified by verification codes, and is mounted on the dispenser 400 in (6) to replace an empty one, and a replaced cartridge is recovered and collected in (7). Upon collection of the cartridge, the integrated management server 200 updates the database 220.

In the present exemplary embodiments, a comprehensive central dispensing system provides central-based healthcare services by systematically connecting consultation offices, a pharmacy system, a drug dispensing system, and a diagnosis data management system.

In the present exemplary embodiments, the central dispensing system may remotely control dispensing of the whole dispensers that are apart from each other, and may monitor overall operations of these dispensers.

Further, in the present exemplary embodiments, the central dispensing system may enable managers (i.e., pharmacists) to directly check whether dispensing is defective or not, to control dispensing of medications, thereby satisfying legal requirements, if any, for dispensing of medication by pharmacists.

In addition, in the present exemplary embodiments, the central dispensing system may receive and manage diagnosis data of patients, and doctors may determine, based on the diagnosis data, patients' response to medications, side effects and effects of medications, or the like to take actions, such as changing or stopping prescription of certain medicines, and the like.

Moreover, in the present exemplary embodiments, the central dispensing system may manage inventory of medications stored in cartridges of dispensers, and if out of stock, the cartridges may be controlled to be delivered, thereby enabling precise management of medication inventory.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A central dispensing management system, comprising:
a prescription server configured to manage prescription data;
an integrated management server configured to receive the prescription data to generate dispensing data that includes information on drug administration; and
a plurality of dispensing management clients configured to control dispensers according to the dispensing data, and to receive image data associated with dispensing according to the controlling,
wherein the plurality of dispensing management clients provide information to a user terminal or to the integrated management server based on the image data associated with the dispensing.

2. The system of claim 1, wherein the integrated management server comprises:
a communication interface configured to be used for communication between the prescription server and consultation offices;
a data processor configured to parse data received from the prescription server through the communication interface, and to transmit diagnosis data of patients to the prescription server through the communication interface; and
a prescription data processor configured to generate dispensing data that includes information on drug administration based on the prescription data obtained by the parsing by the data processor, and to transmit the generated dispensing data to the plurality of dispensing management clients.

3. The system of claim 2, wherein the integrated management server further comprises a diagnosis data processor configured to receive measuring data of patients' conditions from a diagnostor connected to a serial interface, and to receive information on patients from a reader connected to the serial interface, so as to generate diagnosis data that includes the received measuring data of patients' conditions and the information on patients, or to process diagnosis data received from the plurality of dispensing management clients.

4. The system of claim 3, wherein the integrated management server further comprises a database server configured to manage the prescription data obtained by the parsing by the data processor in a database, to manage the diagnosis data processed by the diagnosis data processor in the database, and to receive data of camera-captured dispensing images associated with the dispensing by the dispensers from the plurality of dispensing management clients to manage the data of camera-captured dispensing images in the database.

5. The system of claim 1, wherein the plurality of dispensing management clients comprise:
a controller configured to control the dispensers to perform dispensing according to the dispensing data received from the integrated management server; and
a dispensing image processor configured to receive, from the dispensers, data of camera-captured dispensing images associated with dispensing results to output the data to a screen of the user terminal through a user interface, and to transmit the received data of camera-captured dispensing images to the integrated management server.

6. The system of claim 5, wherein:
the dispensing image processor is configured to receive, from the dispensers, the camera-captured dispensing images and result data on a determination of whether there is a dispensing error based on the camera-captured dispensing images, to output the received data to a screen of the user terminal through the user interface; and
the controller is configured to control the dispensers to progress dispensing or to perform redispensing according to a user's instruction input through the user interface.

7. The system of claim 5, wherein the plurality of dispensing management clients further comprise a diagnosis data receiver configured to receive measuring data of patients' conditions from a diagnostor connected to a serial interface, and to receive information on patients from a reader connected to the serial interface, so as to generate diagnosis data that includes the received measuring data of patients' conditions and the information on patients, and to transmit the generated diagnosis data to the integrated management server.

8. The system of claim 4, wherein the integrated management server further comprises a cartridge manager configured to manage inventory of medicines stored in each cartridge used by the dispensers in the database, and to manage a cartridge to be replaced with a new cartridge in response to a stock of medicines in the cartridge being below a predetermined optimal number of stocks.

9. The system of claim 4, wherein the integrated management server further comprises a cartridge manager configured to manage inventory of medicines stored in each cartridge used by the dispensers by using the database, and to determine, based on a usage history of each cartridge, whether inventory of medicines is below an optimal number of stocks that is changeable, so as to manage a cartridge to be replaced with a new cartridge in response to a determination that a stock of medicines in the cartridge is below an optimal number of stocks.

10. The system of claim 9, wherein the usage history is usage patterns on a monthly, weekly, daily, and hourly basis.

11. A central dispensing management method of an integrated management server, the method, which is performed in a central dispensing management system including a prescription server, the integrated management server, and a plurality of dispensing management clients, comprising:
parsing data received from the prescription server;
separating prescription data from the parsed data;
generating dispensing data that includes information on drug administration based on the prescription data; and
transmitting the generated dispensing data to the plurality of dispensing management clients.

12. The method of claim 11, wherein the central dispensing management method of the integrated management server further comprises storing information on dispensing results and information on dispensing images received from the plurality of dispensing management clients.

13. The method of claim 11, wherein the central dispensing management method of the plurality of dispensing management clients further comprise:
controlling dispensers to perform dispensing according to dispensing data received from the integrated management server;
receiving data of camera-captured dispensing images associated with dispensing results from the dispensers; and
outputting the received data of camera-captured dispensing images to a screen of a user terminal, or transmitting the received data of camera-captured dispensing images to the integrated management server.

14. The method of claim 11, wherein the central dispensing management method of the plurality of dispensing management clients further comprise:
controlling dispensers to perform dispensing according to dispensing data received from the integrated management server;
receiving, from the dispensers, data of camera-captured dispensing images associated with dispensing results and result data on a determination of whether there is a dispensing error;
outputting the received data of camera-captured dispensing images and the received result data on a determination of whether there is a dispensing error; and
controlling the dispensers to progress dispensing or to perform redispensing according to a user's instruction input through a user interface.

15. The method of claim 11, wherein the central dispensing management method of the plurality of dispensing management clients further comprise:
receiving information on patients from a reader;
receiving measuring data of patients' conditions from a diagnostor;
generating diagnosis data that includes the received information on patients and the received measuring data of patients' conditions; and
transmitting the generated diagnosis data to the integrated management server.

16. The method of claim 15, wherein the central dispensing management method of the integrated management server further comprises:
receiving diagnosis data from the plurality of management clients;
converting a format of the received diagnosis data; and
transmitting the format-converted diagnosis data to the prescription server.

17. The method of claim 11, wherein the central dispensing management method of the integrated management server further comprises:
managing inventory of medicines stored in each cartridge used by the dispensers in a database; and
managing a cartridge to be replaced with a new cartridge in response to a stock of medicines in the cartridge being below a predetermined optimal number of stocks.
